(19) United States
(12) Patent Application Publication
(10) Pub. No.: US 2016/0286272 A1
(43) Pub. Date: Sep. 29, 2016

(54) USER-PROFILE GENERATING APPARATUS, MOVIE ANALYZING APPARATUS, MOVIE REPRODUCING APPARATUS, AND NON-TRANSITORY COMPUTER READABLE MEDIUM

(71) Applicant: FUJI XEROX CO., LTD., Tokyo (JP)

(72) Inventors: Roshan THAPLIYA, Kanagawa (JP); Yifang YIN, Kanagawa (JP)

(73) Assignee: FUJI XEROX CO., LTD., Tokyo (JP)

(21) Appl. No.: 14/844,244

(22) Filed: Sep. 3, 2015

(30) Foreign Application Priority Data
Mar. 24, 2015 (JP) 2015-061202

(51) Int. Cl. H04N 21/466; G06K 9/00; G06K 9/62; G11B 27/00; H04N 21/44; H04N 21/45; G11B 27/34

(52) U.S. Cl. CPC H04N 21/4668; H04N 21/4532; G06K 9/00718; G06K 9/00744; G11B 27/34; G11B 27/005; H04N 21/44008; G06K 9/6215; G06K 9/6219; G06K 2009/00738

(57) ABSTRACT

A user-profile generating apparatus includes a first generating unit and second generating unit. The first generating unit uses the degree of similarity among reference images to generate tree structure information describing a relationship among the reference images by using a tree structure. The degree of similarity is obtained from feature values of the reference images. The second generating unit uses feature values of target images owned by a user and the feature values of the reference images corresponding to leaf nodes in the tree structure to generate a user profile in which the degree of interest of the user is assigned to each node in the tree structure.

### CROSS-REFERENCE TO RELATED APPLICATIONS

This application is based on and claims priority under 35 USC 119 from Japanese Patent Application No. 2015-061202 filed Mar. 24, 2015.

### BACKGROUND

### Technical Field

The present invention relates to a user-profile generating apparatus, a movie analyzing apparatus, a movie reproducing apparatus, and a non-transitory computer readable medium.

### SUMMARY

According to an aspect of the invention, there is provided a user-profile generating apparatus including a first generating unit and second generating unit. The first generating unit uses the degree of similarity among reference images to generate tree structure information describing a relationship among the reference images by using a tree structure. The degree of similarity is obtained from feature values of the reference images. The second generating unit uses feature values of target images owned by a user and the feature values of the reference images corresponding to leaf nodes in the tree structure to generate a user profile in which the degree of interest of the user is assigned to each node in the tree structure.

### BRIEF DESCRIPTION OF THE DRAWINGS

Exemplary embodiment of the present invention will be described in detail based on the following figures, wherein:

FIG. 1 is a block diagram illustrating an electrical configuration of a movie reproducing apparatus according to an exemplary embodiment;

FIG. 2 is a schematic diagram illustrating the configuration of an image file according to the exemplary embodiment;

FIG. 3 is a flowchart of a process performed by using a program for a user-profile generating process according to the exemplary embodiment;

FIG. 4 is a schematic diagram illustrating exemplary reference images according to the exemplary embodiment;

FIG. 5 is a graph showing a relationship between the normalized discounted cumulated gain (nDCG) and coefficients used in an expression for calculating the degree of similarity among multiple reference images, in the movie reproducing apparatus according to the exemplary embodiment;

FIG. 6 is a schematic diagram illustrating exemplary tree structure information describing a relationship for reference images, according to the exemplary embodiment;

FIG. 7 is a schematic diagram illustrating exemplary target images according to the exemplary embodiment;

FIG. 8 is a schematic diagram illustrating an exemplary user profile according to the exemplary embodiment;

FIG. 9 is a flowchart of a process performed by using a program for a movie reproducing process according to the exemplary embodiment;

FIG. 10 is a schematic diagram illustrating an exemplary reference image according to the exemplary embodiment;

FIG. 11 is a schematic diagram illustrating exemplary movie sections according to the exemplary embodiment;

FIG. 12 is a schematic diagram illustrating exemplary reproduction priorities for movie sections before adjustment of the reproduction priorities for the movie sections, and exemplary reproduction priorities for the movie sections after the adjustment, according to the exemplary embodiment;

FIG. 13A is a schematic diagram illustrating exemplary display of a movie to be reproduced, in the movie reproducing apparatus according to the exemplary embodiment;

FIG. 13B is a schematic diagram illustrating exemplary display produced in the case where the reproduction priority for a movie section is changed when the movie reproducing apparatus according to the exemplary embodiment is to display the movie to be reproduced;

FIG. 14 is a table showing the average of nDCG obtained when the degree of random similarity among reference images is used, that obtained when only the degree of visual similarity is used, that obtained when only the degree of semantic similarity is used, that obtained when only the degree of social similarity is used, and that obtained when the degrees of similarity are added as in the exemplary embodiment;

FIG. 15 is a table showing the average of nDCG obtained when the reproduction priorities for movie sections are set at random, that obtained when the reproduction priorities for the movie sections are calculated by using a related art method A, that obtained when the reproduction priorities for the movie sections are calculated by using a related art method B, and that obtained when the reproduction priorities for the movie sections are calculated by using a method according to the exemplary embodiment of the present invention;

FIG. 16 is a schematic diagram illustrating a method for setting reproduction priorities for movie sections according to the related art method B; and

FIG. 17 is a graph illustrating nDCG values obtained when the reproduction priorities for movie sections are calculated by using the related art method A, those obtained when the reproduction priorities for the movie sections are calculated by using the related art method B, and those obtained when the reproduction priorities for the movie sections are calculated by using the method according to the exemplary embodiment.

### DETAILED DESCRIPTION

An exemplary embodiment of the present invention will be described in detail below with reference to the attached drawings.

A movie reproducing apparatus according to the exemplary embodiment will be described.

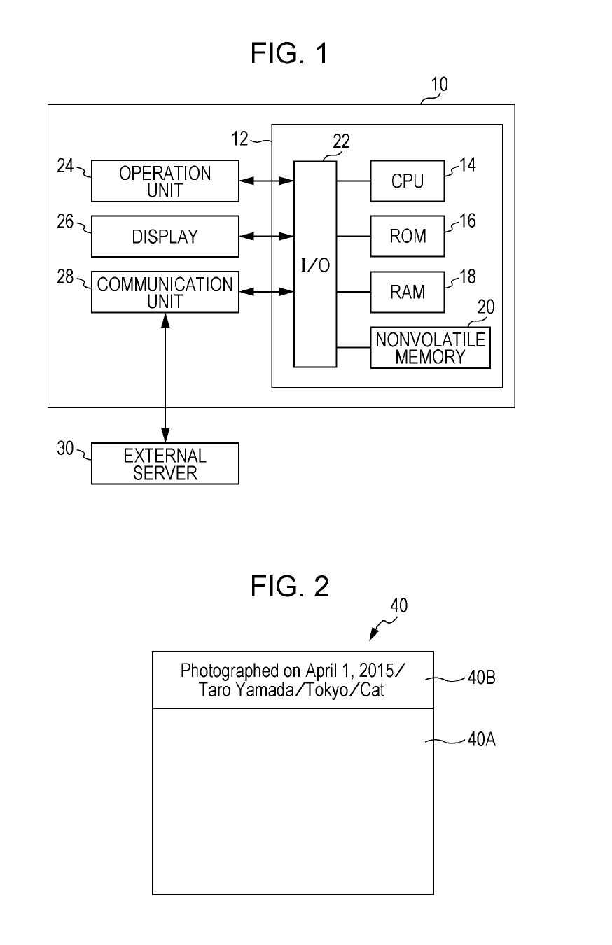

As illustrated in FIG. 1, a movie reproducing apparatus 10 according to the exemplary embodiment includes a controller 12 controlling the entire apparatus. The controller 12 includes a central processing unit (CPU) 14 executing various processes including an image evaluation process described below, and a read only memory (ROM) 16 used to store programs and various types of information which are used in processes performed by the CPU 14. The controller 12 also includes a random access memory (RAM) 18 which serves as a work area for the CPU 14 and which is used to store various data temporarily, and a nonvolatile memory 20 used to store various types of information used in the processes performed by the CPU 14. The controller 12 further includes an input/output (I/O) interface 22 inputting/outputting data from/to an external apparatus connected to the movie reproducing apparatus 10.

An operation unit 24 operated by a user, a display 26 for displaying various types of information, and a communication unit 28 communicating with external apparatuses including an external server 30 are connected to the I/O interface 22.

The external server 30 is connected to the movie reproducing apparatus 10 via the communication unit 28. Many image files owned by multiple users are stored in the external server 30. These many image files are transmitted from multiple client terminals including the movie reproducing apparatus 10, to the external server 30.

For example, as illustrated in FIG. 2, tag information 40B describing a shooting date and time, a photographer, a shooting place, a photographed target, and the like is added to image information 40A indicating an image in an image file 40. The photographed target is represented by words representing the kind of the photographed object. For example, the photographed target of an image obtained by photographing a cat is represented by “cat”.

Assume that a specific word is specified as a keyword by using a client terminal when images stored in the external server 30 are viewed on the client terminal. In this case, the external server 30 refers to the tag information 40B to extract image files corresponding to the keyword, and transmits the extracted image files to the client terminal. Thus, each user may view images which are owned by the user or owned by other users and which correspond to the desired keyword, on his/her client terminal.

Thus, many images owned by multiple users are stored in the external server 30. In the exemplary embodiment, feature values of multiple images owned by each user are analyzed, and a user profile reflecting the degree of interest of the user is generated. The generated user profile is applicable to various techniques in various fields.

The movie reproducing apparatus 10 according to the exemplary embodiment uses the degree of similarity among multiple images (reference images) which is obtained from feature values of the images, and generates tree structure information representing a relationship among multiple reference images by using the tree structure. The movie reproducing apparatus 10 uses feature values of multiple images (target images) owned by the user and reference images corresponding to the leaf nodes in the tree structure, and generates a user profile in which the degree of interest of the user is assigned to each node in the tree structure. Then, the movie reproducing apparatus 10 uses the generated user profile to reproduce a movie by using a reproducing method appropriate for each user.

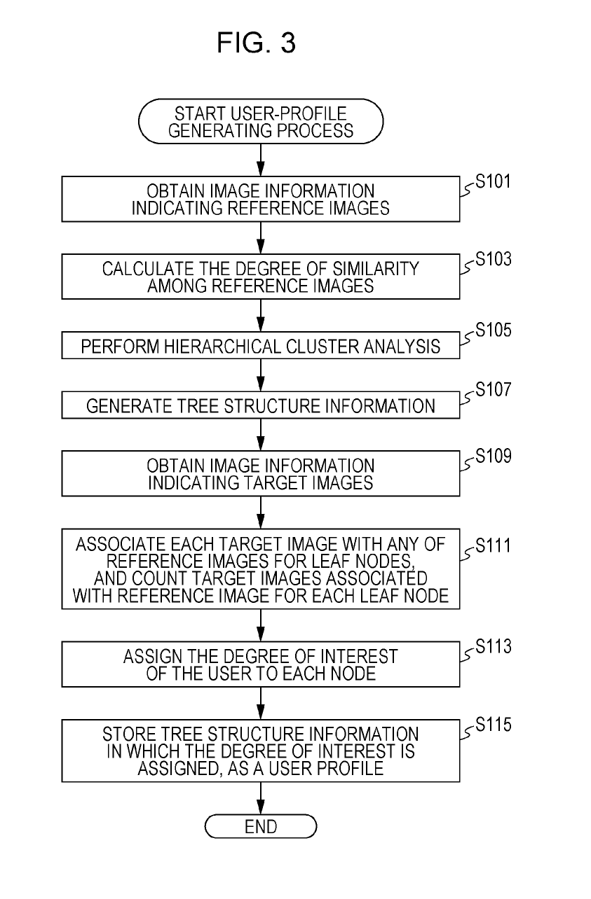

The process flow executed when a user-profile generating process is performed by the CPU 14 of the movie reproducing apparatus 10 according to the exemplary embodiment will be described with reference to the flowchart illustrated in FIG. 3.

In the exemplary embodiment, the program for the user-profile generating process is stored in advance in the nonvolatile memory 20, but the exemplary embodiment is not limiting. For example, the program for the user-profile generating process may be received via the communication unit 28 from an external apparatus and executed. The program for the user-profile generating process which is stored in a recording medium such as a compact disc-read-only memory (CD-ROM) may be read via the I/O interface 22 by using a CD-ROM drive or the like, whereby the user-profile generating process is performed.

For example, when an instruction to execute the program for the user-profile generating process is supplied by using the operation unit 24, the program is executed.

Alternatively, the program for the user-profile generating process may be executed at a timing at which an image file is transmitted to the external server 30.

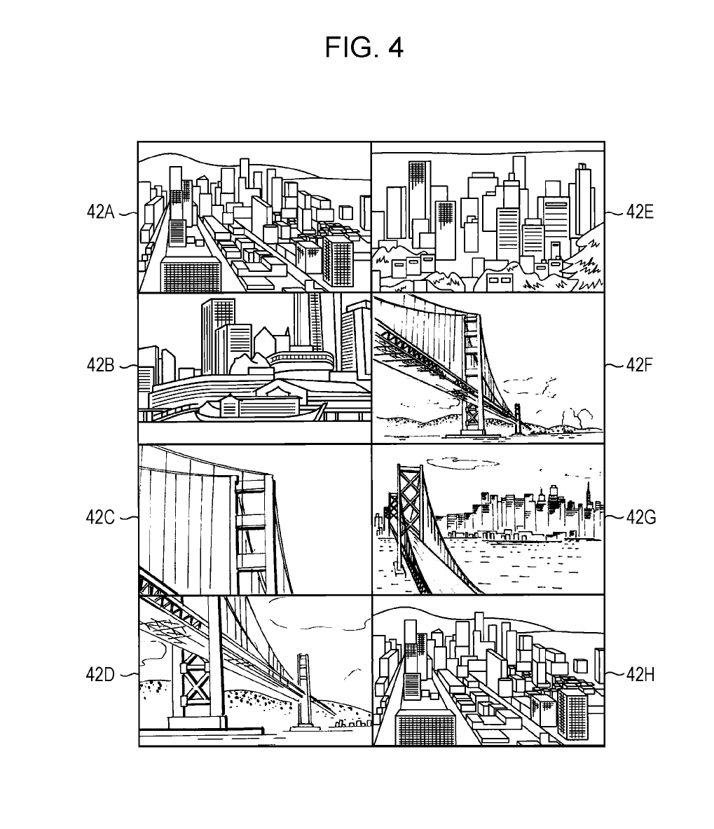

In step S101, image information indicating multiple reference images is obtained. In the exemplary embodiment, a predetermined number (for example, 1000) of image files owned by multiple users are obtained from the external server 30. For example, as illustrated in FIG. 4, the multiple reference images include landscape images 42A, 42B, 42E, and 42H obtained by photographing a town in which buildings stand, landscape images 42C, 42D, 42F, and 42G obtained by photographing a bridge.

In step S103, the degree of similarity among the multiple reference images indicated by the obtained pieces of image information is calculated. In the exemplary embodiment, the degree of visual similarity obtained from visual features, the degree of semantic similarity obtained from semantic features, and the degree of social similarity obtained from the relationship between the owners of the multiple reference images and the reference image are calculated. Then, the calculated degrees of similarity are added, whereby the degree of similarity between reference images is calculated.

The degree of visual similarity VS(Iᵢ, Iⱼ) between the ith reference image Iᵢ and the jth reference image Iⱼ is obtained by using Expression (1) described below, where Xᵢ represents feature values of the ith reference image, Xⱼ represents feature values of the jth reference image, σ is the average of differences between the feature values of the ith reference image and the feature values of the jth reference image.

$$VS ( {I}_{i} , {I}_{j} ) = exp ( - \frac{{‖ {X}_{i} - {X}_{j} ‖}_{2}^{2}}{σ} ) \qquad ( 1 )$$

The degree of semantic similarity TS(Iᵢ, Iⱼ) between the reference image Ii and the reference image Iⱼ is obtained as the average of the degrees of similarity Sim(tᵢ, tⱼ) obtained by using Expressions (2) and (3) described below. The parameters in Expressions (2) and (3) described below are obtained by applying, to WordNet, the words representing the photographed targets included in the tag information 40B of the reference image Iᵢ and the reference image Iⱼ.

WordNet is a known conceptual dictionary (semantic dictionary), and is a conceptual dictionary database using tree structure information having a hierarchical structure in which many words are defined in a relationship expressed with higher and lower levels. The expression lso(tᵢ, tⱼ) in Expression (2) described below represents a word serving as a parent node of both of a word tᵢ and a word tⱼ in WordNet; hypo(t) represents the number of child nodes of a word t; and deep(t) represents the number of hierarchies for the word t. The symbol nodeₘₐₓ represents the maximum number of nodes in WordNet, deepₘₐₓ represents the maximum number of node hierarchies, and k is a constant.

$$\begin{matrix}Sim ( {t}_{i} , {t}_{j} ) = \frac{2 IC ( lso ( {t}_{i} , {t}_{j} ) )}{IC ( {t}_{i} ) + IC ( {t}_{j} )} & ( 2 ) \\ IC ( t ) = k ( 1 - \frac{log ( hypo ( t ) + 1 )}{log ( {node}_{max} )} ) + ( 1 - k ) ( \frac{log ( deep ( t ) )}{log ( {deep}_{max} )} ) & ( 3 )\end{matrix}$$

In the exemplary embodiment, the case in which WordNet is used to calculate the degree of semantic similarity TS(Iᵢ, Iⱼ) is described, but the exemplary embodiment is not limiting. Any dictionary database using tree structure information having a hierarchical structure in which many words are defined in a relationship expressed with higher and lower levels may be used to calculate the degree of semantic similarity TS (Iᵢ, Iⱼ).

The degree of social similarity SS(Iᵢ, Iⱼ) between the reference image Iᵢ and the reference image Iⱼ is obtained by using Expressions (4) to (6) described below, where eᵢ represents a unit vector; W represents a matrix representing a relationship between users and reference images; and c represents a constant.

$$\begin{matrix}{\vec{r}}_{0} = {\vec{e}}_{i} & ( 4 ) \\ {\vec{r}}_{i} = c \tilde{W} {\vec{r}}_{i - 1} + ( 1 - c ) {\vec{e}}_{i} & ( 5 ) \\ [ \begin{matrix}SS ( {I}_{1} , {I}_{1} ) & SS ( {I}_{1} , {I}_{2} ) & … & … \\ SS ( {I}_{2} , {I}_{1} ) & … & … & … \\ … & … & … & … \\ … & … & … & …\end{matrix} ] = [ {\vec{r}}_{1} {\vec{r}}_{2} … … ] & ( 6 )\end{matrix}$$

The degree of similarity between the reference image Iᵢ and the reference image Iⱼ which is used in the exemplary embodiment is obtained by using Expression (7) described below, where α, β, and γ (α+β+γ=1) are constants.

Sim(Iᵢ,Iⱼ)=αVS(Iᵢ,Iⱼ)+βTS(Iᵢ,Iⱼ)+γSS(Iᵢ,Iⱼ) (7)

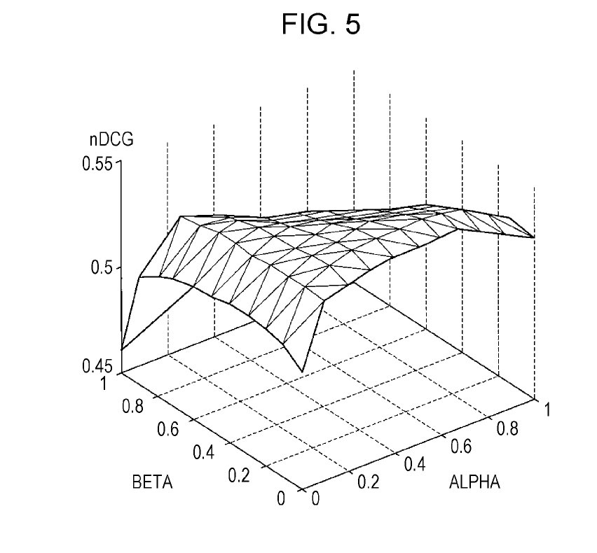

The constants α, β, and γ in Expression (7) are determined by using the value of normalized discounted cumulated gain (nDCG) which is an index whose value is set larger as more correct ranking is assigned to targets to be evaluated. For example, FIG. 5 illustrates a graph illustrating the relationship which exists between nDCG and combinations of the constants α and β and which is obtained when an nDCG value is calculated for each combination of a and β. As illustrated in FIG. 5, the values of the constants α and β are determined from a combination of the constants α and β which produces the largest nDCG value. The determined values of α and β are used to perform calculation using the expression, γ=1−α−β, whereby the value of γ is determined.

An nDCG value is obtained by using Expressions (8) and (9) described below, where k represents the maximum number of targets to be subjected to ranking, relᵢ represents the degree of similarity of the target at position i in ranking, and idealDCG represents the maximum value of DCG.

$$\begin{matrix}DCG = {\sum }_{i} \frac{{2}^{{rel}_{i}} - 1}{{log}_{2} ( i + 1 )} & ( 8 ) \\ {nDCG}_{k} = \frac{{DCG}_{k}}{ideal {DCG}_{k}} & ( 9 )\end{matrix}$$

In step S105, the calculated degree of similarity among the multiple reference images is used to perform hierarchical cluster analysis. As a method for performing cluster analysis, a known technique, such as the nearest neighbor method, the furthest neighbor method, the group average method, and the Ward's method, may be used.

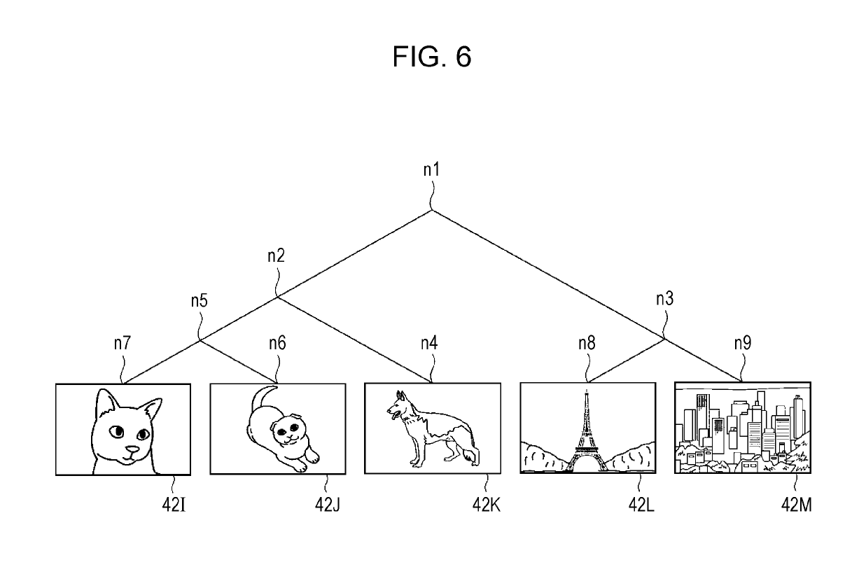

In step S107, in accordance with the result of the hierarchical cluster analysis, tree structure information representing the relationship among the reference images is generated by using each reference image as a leaf node. For example, as illustrated in FIG. 6, a root node n1 branches off to an animal node n2 and a landscape node n3 in tree structure information. Further, the animal node n2 branches off to a dog leaf node n4 and a cat node n5 which branches off to a cat-A leaf node n6 and a cat-B leaf node n7 depending on the kind of a cat. The landscape node n3 branches off to an Eiffel-Tower leaf node n8 and a town leaf node n9.

The cat-B leaf node n7 is associated with a reference image 42I; and the cat-A leaf node n6, with a reference image 42J. The dog leaf node n4 is associated with a reference image 42K; the Eiffel-Tower leaf node n8, with a reference image 42L; and the town leaf node n9, with a reference image 42M.

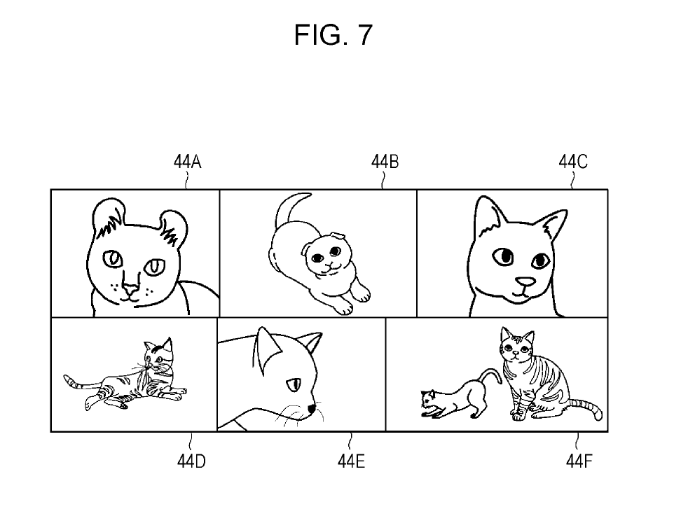

In step S109, image information indicating multiple target images is obtained. In the exemplary embodiment, a predetermined number (for example, 100) of image files owned by a user to be analyzed are obtained from the external server 30. For example, as illustrated in FIG. 7, the multiple target images include cat images 44A to 44F. From this, it is found that the user owning these target images has a higher degree of interest for cats.

In step S111, in the tree structure information illustrated in FIG. 6, the feature value data of each target image is compared with those of the reference images for the leaf nodes one by one. On the basis of the comparison result, each target image is associated with one of the reference images for the leaf nodes. For example, a known k-nearest neighbor algorithm is used in this associating process. The target images associated with the reference image for each leaf node are counted.

In step S113, the degree of interest of the user is assigned to each node. First, the degree of interest of the user is assigned to each leaf node. The degree of interest is set, for example, at a ratio of the number of target images associated with the reference image for the leaf node, to the number of all of the target images. That is, the larger the number of target images associated with a leaf node is, the higher the degree of interest is. Then, the degree of interest is assigned to the parent node which is a higher node directly connected to a leaf node. Specifically, for example, a value obtained by adding all of the degrees of interest which are assigned to all of the leaf nodes to which a parent node branches off is assigned as the degree of interest for the parent node. By repeating this assignment of the degree of interest until the root node, the degree of interest is assigned to each node.

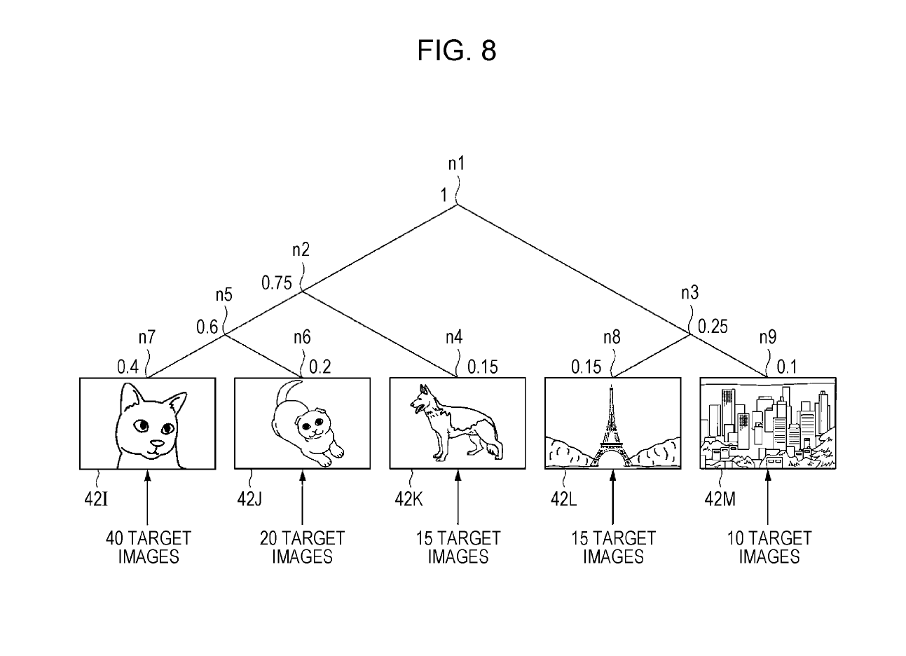

For example, as illustrated in FIG. 8, assume that 40 target images are associated with the cat-B reference image 42I; 20 target images, with the cat-A reference image 42J; and 15 target images, with the dog reference image 42K. In addition, assume that 15 target images are associated with the Eiffel-Tower reference image 42L; and 10 target images, with the town reference image 42M.

In this case, 0.15 is assigned to the dog leaf node n4 as the degree of interest; 0.15, to the Eiffel-Tower leaf node n8; and 0.1, to the town leaf node n9. To the cat node n5 having the cat-A leaf node n6 and the cat-B leaf node n7 as descendant nodes, 0.6 which is obtained by adding the degree of interest, 0.4, of the cat-A leaf node n6 to the degree of interest, 0.2, of the cat-B leaf node n7 is assigned as the degree of interest. To the animal node n2 having the dog leaf node n4 and the cat node n5 as descendant nodes, 0.75 obtained by adding the degree of interest, 0.15, of the dog node n4 to the degree of interest, 0.6, of the cat node n5 is assigned as the degree of interest.

To the landscape node n3 having the Eiffel-Tower leaf node n8 and the town leaf node n9 as descendant nodes, 0.25 obtained by adding the degree of interest, 0.15, of the Eiffel-Tower leaf node n8 to the degree of interest, 0.1, of the town leaf node n9 is assigned as the degree of interest. To the root node n1 having the animal node n2 and the landscape node n3 as child nodes, 1 obtained by adding the degree of interest, 0.75, of the animal node n2 to the degree of interest, 0.25, of the landscape node n3 is assigned as the degree of interest. Thus, it is found that the user owning these target images has a high degree of interest for cats because the degree of interest for the cat node n5 is higher than that for dog leaf node n4 and that for the landscape node n3.

In step S115, the tree structure information in which the degree of interest is assigned to each node is stored as a user profile in the nonvolatile memory 20, and the execution of the program for the user-profile generating process is ended.

This user-profile generating process is performed for each user, and a user profile for the user is generated and stored, whereby each user profile is used in various situations. In the exemplary embodiment, a case in which the generated user profile is used when a movie reproducing process suitable for the user is performed will be described.

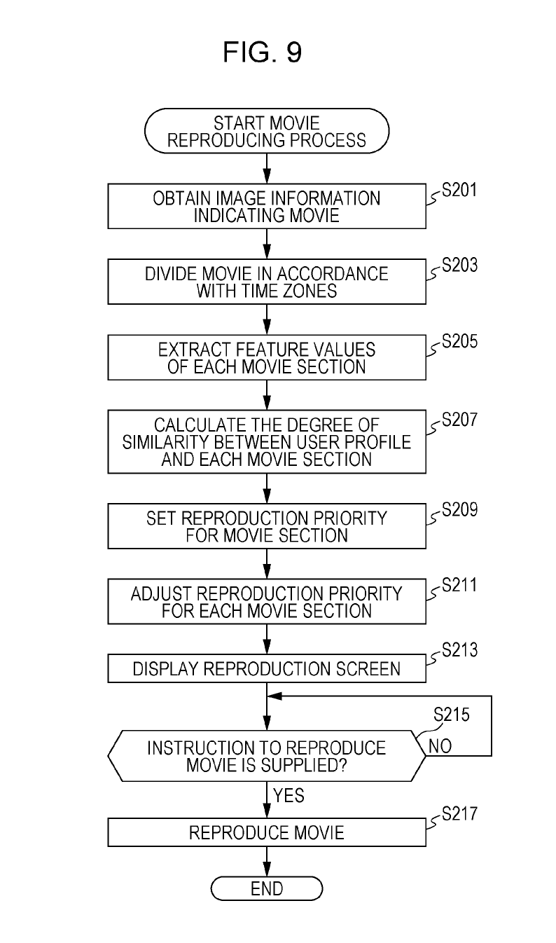

The process flow for a movie reproducing process performed when the CPU 14 of the movie reproducing apparatus 10 according to the exemplary embodiment receives an instruction to execute the process, through the operation unit 24 will be described with reference to the flowchart illustrated in FIG. 9.

In the exemplary embodiment, the program for the movie reproducing process is stored in advance in the nonvolatile memory 20, but the exemplary embodiment is not limiting. For example, the program for the movie reproducing process may be received via the communication unit 28 from an external apparatus and stored in the nonvolatile memory 20. Alternatively, the program for the movie reproducing process which is stored in a recording medium such as a CD-ROM may be read via the I/O interface 22 by using a CD-ROM drive or the like, whereby the movie reproducing process is performed.

In step S201, image information indicating a movie to be reproduced is obtained. In the exemplary embodiment, image information stored in the external server 30 is obtained via the communication unit 28.

In step S203, movie sections obtained by dividing the movie indicated by the obtained image information, in accordance with multiple time zones are generated. As the method for dividing a movie, a known technique, such as a method in which a movie is divided at every predetermined time, or a method in which scene switching is extracted from a change in feature values of each of the frames constituting a movie and in which the movie is divided into scenes, may be used.

In step S205, feature values of each movie section is extracted. First, a similarity score S1 obtained from the degree of similarity between the user profile and a movie section is calculated. Specifically, the frames included in the movie section are used as target images to perform the user-profile generating process illustrated in FIG. 3, and tree structure information for the movie section is generated. Then, the degree of similarity obtained from the cosine similarity is calculated as the similarity score S1 for each corresponding node pair of the user profile and the tree structure information for the movie section.

The degree of similarity using the cosine similarity takes a value from 0 to 1. A value closer to 1 indicates a higher degree of similarity. The degree of similarity cos(x, y) is obtained by using Expression (10) described below, where a vector V represents the degrees of interest which are set to nodes in the tree structure information, xᵢ represents the ith degree of interest in the vector V in the user profile, and yᵢ represents the ith degree of interest in the vector V in the movie section.

$$cos ( \vec{x} , \vec{y} ) = \frac{{\sum }_{i = 1}^{\vert V \vert} {x}_{i} {y}_{i}}{\sqrt{{\sum }_{i = 1}^{\vert V \vert} {x}_{i}^{2}} \cdot \sqrt{{\sum }_{i = 1}^{\vert V \vert} {y}_{i}^{2}}}$$

Then, a saliency score S2 obtained by using a saliency map of an image is calculated. The saliency map of an image is obtained by calculating a visual saliency for each pixel in the image. In the exemplary embodiment, for example, a known method is used to generate a saliency map for each frame included in a movie section. The average of corresponding pixels of the generated saliency maps is calculated, whereby the saliency map for the movie section is generated. In the exemplary embodiment, the saliency score S2 is directly obtained from the saliency maps for the frames. In this process, as described below, a Gaussian kernel is applied to each pixel in a saliency map so that noise is reduced.

The saliency score S2 is expressed with two elements on the basis of the generated saliency maps of a movie section. A first element is a weighted sum of the pixels in a saliency map. The weighted sum Sum(smap, Q) is obtained by using Expression (11) described below. In Expression (11), smap(i, j) represents a pixel value at coordinates (i, j) in the saliency map before the Gaussian kernel is applied, and Q(i, j) represents the Gaussian kernel which is set on the saliency map.

$$Sum ( smap , Q ) = {\sum }_{i , j} Q ( i , j ) \cdot smap ( i , j ) \qquad ( 11 )$$

A second element is based on the fact that a human being tends to focus on the center of an image. The information amount D_{KL} representing the difference between an ideal distribution P representing an ideal distribution at the center of the image by using the normal distribution and the Gaussian kernel Q which is set on the saliency map is obtained by using Expression (12) and by using the Kullback-Leibler divergence (KLD) which is a known calculation method. In Expression (12), p(u) represents the distribution density of the ideal distribution P, and q(u) represents the distribution density of the Gaussian kernel Q.

$${D}_{KL} ( P ‖ Q ) = {\int }_{- ∞}^{∞} ln ( \frac{p ( u )}{q ( u )} ) p ( u ) d u \qquad ( 12 )$$

By using the weighted sum Sum(smap, Q) of a saliency map which is the first element, and the information amount D_{KL} which represents the difference between the ideal distribution P and the Gaussian kernel Q and which is the second element, the saliency score AS(F) for a frame F is obtained by using Expression (13) described below. In Expression (13), smap_{f} represents a pixel value smap(i, j) in the frame F, and Q_{f} represents the Gaussian kernel Q for the frame F.

$$AS ( F ) = \frac{Sum ( {smap}_{f} , {Q}_{f} )}{{D}_{KL} ( P ‖ {Q}_{f} )} \qquad ( 13 )$$

In the exemplary embodiment, the saliency score S2 is defined as the average ASᵢ of the saliency scores AS(F) for the frames F. The average ASᵢ is obtained by using Expression (14) described below, where the ith frame is represented by Fᵢ.

$${AS}_{i} = \frac{1}{‖ {\tilde{F}}_{i} ‖} {\sum }_{F ∈ {\tilde{F}}_{i}} AS ( F ) \qquad ( 14 )$$

In step S207, the degree of similarity S between the user profile and each movie section is calculated. In the exemplary embodiment, a value obtained by adding the above-described similarity score S1 and the above-described saliency score S2 together is calculated as the degree of similarity S between the user profile and the movie section. The similarity score S1 and the saliency score S2 may be added together after at least one of the similarity score S1 and the saliency score S2 is weighted.

In step S209, in accordance with the degree of similarity S between the user profile and each movie section, reproduction priority for the movie section is set. In the exemplary embodiment, the reproduction priority for each movie section is set so that the reproduction priority is set higher when the degree of similarity S between the user profile and the movie section is higher.

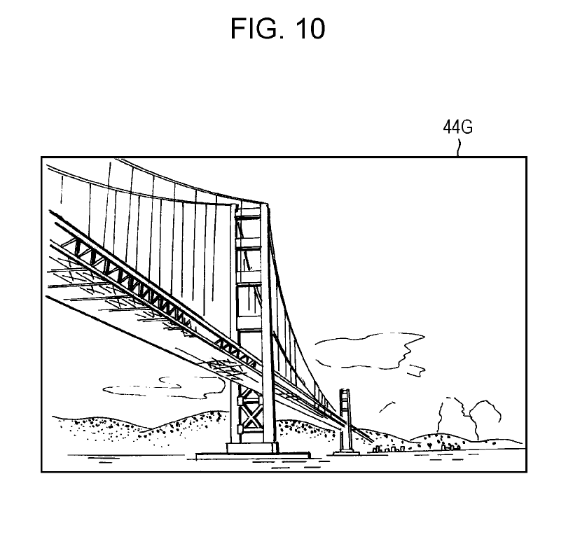

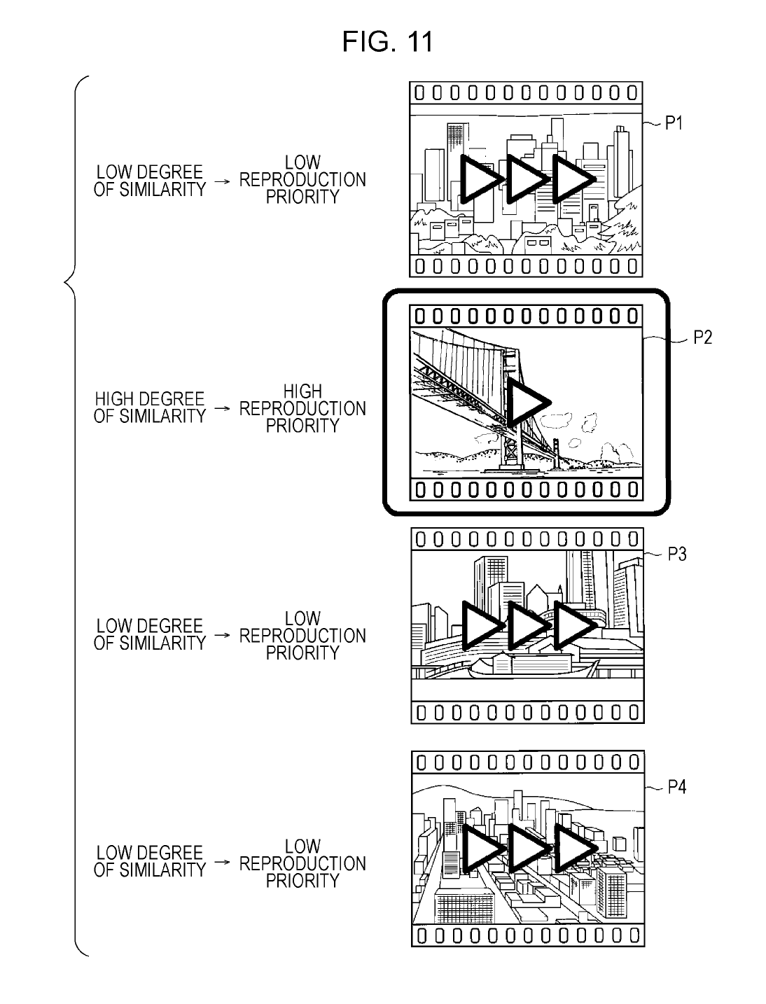

For example, assume that a user owns many bridge images, such as an image 44G which is obtained by photographing a bridge and which is illustrated in FIG. 10. In this case, for example, as illustrated in FIG. 11, among multiple movie sections P1 to P4, similarity for the movie section P2 including an image obtained by photographing a bridge is set higher. Therefore, reproduction priority is set to each of the movie sections P1 to P4 so that the reproduction priority for the movie section P2 including an image obtained by photographing a bridge is set higher and the reproduction priorities for the movie sections P1, P3, and P4 which do not include an image obtained by photographing a bridge are set lower.

In step S211, the reproduction priority for each movie section is adjusted on the basis of the reproduction priorities for the adjacent movie sections before and after the movie section. In the exemplary embodiment, a first difference between the reproduction priority for the target movie section which is a movie section to be adjusted and the reproduction priority for the adjacent movie section before the target movie section is calculated. In addition, a second difference between the reproduction priority for the target movie section and the reproduction priority for the adjacent movie section after the target movie section is calculated. Then, when both of the first difference and the second difference are equal to or more than a predetermined threshold, the reproduction priority for the target movie section is adjusted so that the first difference and the second difference are less than the threshold. The above-described predetermined threshold is one for determining whether or not the movie to be reproduced is smoothly reproduced. For example, the threshold is a value that is smaller than the difference between the maximum and the minimum of the reproduction priority which is set to the movie sections, and that is larger than the half of the difference. In the adjustment, one of the reproduction priorities for the adjacent movie sections before and after the target movie section may be set to the reproduction priority for the target movie section. Alternatively, the average of the reproduction priorities for the adjacent movie sections before and after the target movie section may be set to the reproduction priority for the target movie section.

For example, in the case where “high” or “low” is set as the reproduction priority for each movie section, when a movie section has a high reproduction priority and both of the just before and just after movie sections have a low reproduction priority, reproduction priority is adjusted so that the reproduction priority for the movie section is set low. When a movie section has a low reproduction priority and both of the just before and just after movie sections has a high the reproduction priority, reproduction priority is adjusted so that the reproduction priority of the movie section is set high.

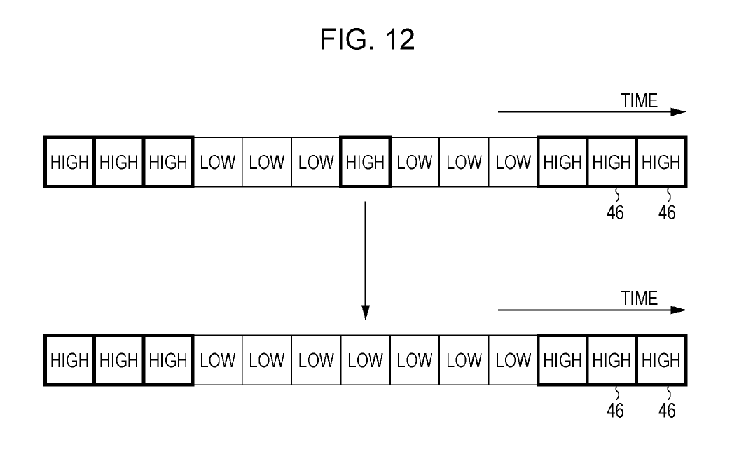

For example, as illustrated in FIG. 12, in the time zone of a sequence of movie sections 46 having a high reproduction priority, the reproduction priorities for the movie sections 46 remain high. In contrast, in the case where a movie section 46 having a high reproduction priority is present among movie sections 46 having a low reproduction priority, adjustment is made so that the reproduction priority for the movie section 46 is set low. Similarly, in the time zone of a sequence of movie sections 46 having a low reproduction priority, the reproduction priorities for the movie sections 46 remain low. In the case where a movie section 46 having a low reproduction priority is present among movie sections 46 having a high reproduction priority, adjustment is made so that the reproduction priority for the movie section 46 is set high. Thus, the movie to be reproduced is smoothly reproduced.

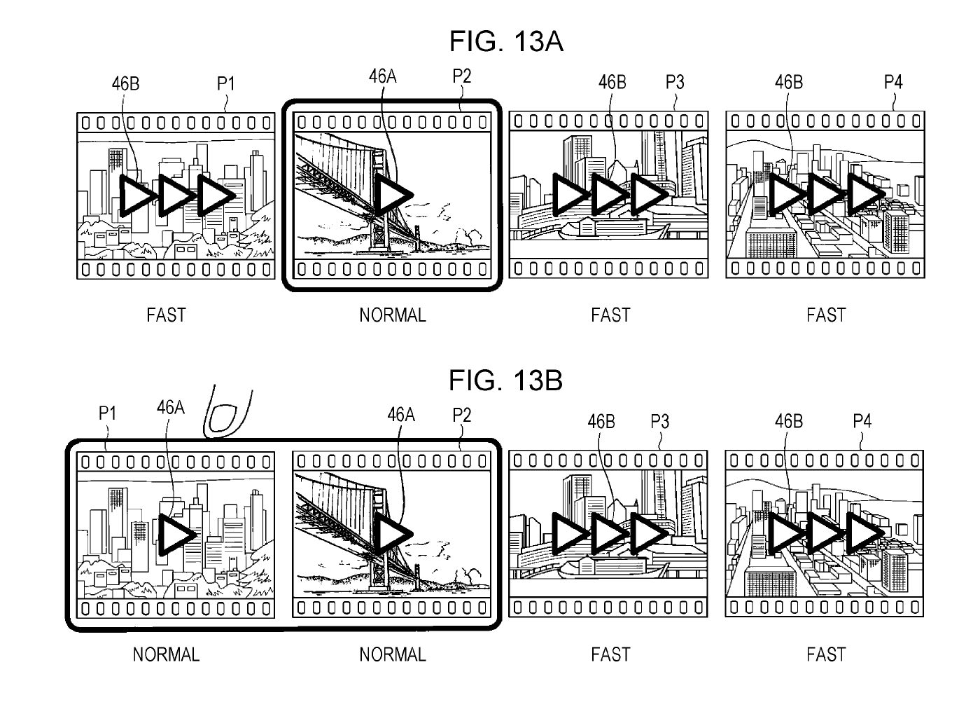

In step S213, the display 26 is controlled so that a reproduction screen for the movie is displayed. For example, as illustrated in FIG. 13A, each movie section in the movie to be reproduced is displayed in a state in which a reproduction arrow 46A or 46B representing reproduction priority is attached to the movie section. The reproduction arrow 46A represented by one arrow indicates that the reproduction priority is high, and the reproduction arrow 46B represented by three arrows indicates that the reproduction priority is low.

In the exemplary embodiment, when a user uses the operation unit 24 to input an instruction to change the reproduction priority for any movie section, the reproduction priority for the specified movie section is changed. For example, as illustrated in FIG. 13B, when the operation unit 24 is used to give an instruction to set the reproduction priority for a movie section having a low reproduction priority, to high, the reproduction priority is changed so that the reproduction priority for the movie section is set high.

In step S215, whether or not an instruction to reproduce the movie is supplied is determined. In the exemplary embodiment, when a reproduction instruction is input by using the operation unit 24, it is determined that an instruction to reproduce the movie is supplied.

If it is determined that an instruction to reproduce the movie is supplied in step S215 (YES in step S215), the process proceeds to step S217. If it is determined that an instruction to reproduce the movie is not supplied in step S215 (NO in step S215), the process in step S215 is repeatedly performed until it is determined that an instruction to reproduce the movie is supplied.

In step S217, the movie is reproduced. In the exemplary embodiment, in the process of reproducing the movie, a movie section having a high reproduction priority is reproduced at a normal reproduction speed, and a movie section having a low reproduction priority is reproduced at a reproduction speed faster than the normal reproduction speed. Thus, a movie section presumed not to be video which the user does not like is automatically fast-forwarded.

In the exemplary embodiment, the case in which the reproduction speed of each movie section is changed in accordance with the reproduction priority for the movie section is described, but the exemplary embodiment is not limiting. For example, only movie sections having a high reproduction priority may be reproduced. Thus, only movie sections presumed to be video which the user likes are automatically selected and reproduced.

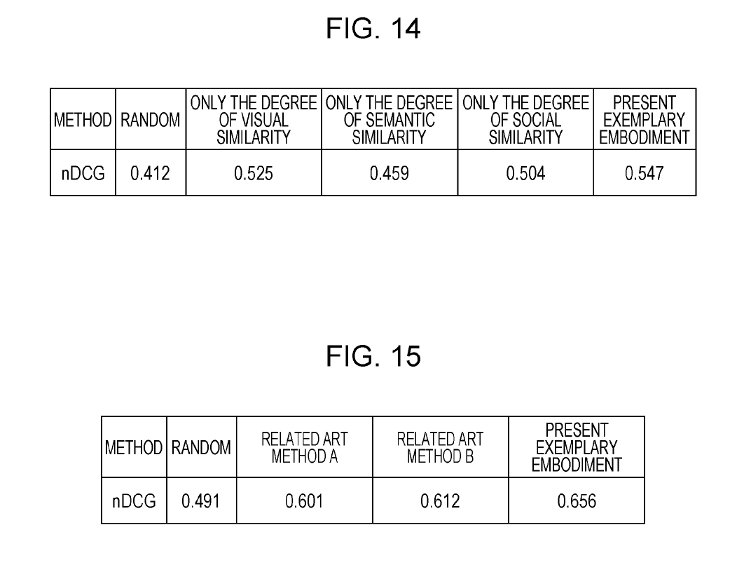

FIG. 14 illustrates the average of nDCG obtained when the degree of random similarity among reference images is used, that obtained when only the degree of visual similarity is used, that obtained when only the degree of semantic similarity is used, that obtained when only the degree of social similarity is used, and that obtained when the degrees of similarity are added as in the exemplary embodiment. In the exemplary embodiment, as described above, the degree of similarity among multiple reference images is calculated by adding together the degree of visual similarity, the degree of semantic similarity, and the degree of social similarity.

FIG. 14 shows that the average of nDCG which is obtained when the degrees of similarity are added as in the exemplary embodiment is the highest. That is, when the degree of similarity among multiple reference images is calculated by adding together the degree of visual similarity, the degree of semantic similarity, and the degree of social similarity, the result may indicate the most correct ranking.

FIG. 15 illustrates the average of nDCG obtained when the reproduction priorities for movie sections are calculated at random, that obtained when the reproduction priorities for the movie sections are calculated by using a related art method A, that obtained when the reproduction priorities for the movie sections are calculated by using a related art method B, and that obtained when the reproduction priorities for the movie sections are calculated by using a method according to the exemplary embodiment of the present invention. The average of nDCG is the average of nDCG obtained from assessments made by 20 users.

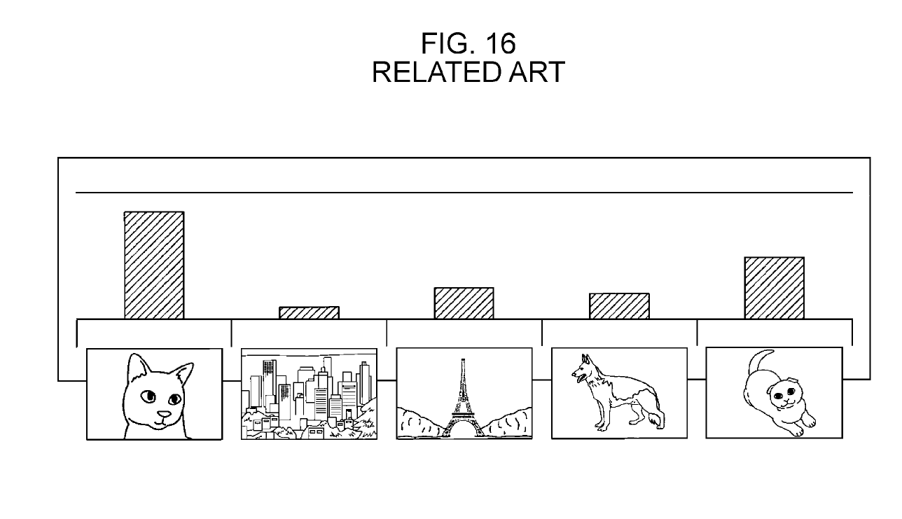

The related art method A is a method in which the degree of similarity between each frame included in a movie section and the target image is calculated by using pattern matching or the like, and in which the reproduction priority for each movie section is set on the basis of the calculated degrees of similarity. For example, as illustrated in FIG. 16, in the related art method B, feature values are extracted for each of the target images and the reference images, for example, by using a k-nearest neighbor algorithm; the number of target images associated with each reference image is calculated; and a user profile in which the information about the number of target images is regarded as the degree of interest is generated. In addition, in the related art method B, feature values are extracted also for each frame included in a movie section, for example, by using a k-nearest neighbor algorithm, and the number of target images associated with each reference image is calculated. By comparing the calculated number of target images with the user profile, the reproduction priority for each movie section is set.

FIG. 15 shows that the average of nDCG obtained when the reproduction priority for a movie section is calculated by using the method according to the exemplary embodiment of the present invention is the highest. That is, when the reproduction priority for a movie section is calculated by using a method according to the exemplary embodiment of the present invention, the result may indicate the most correct ranking.

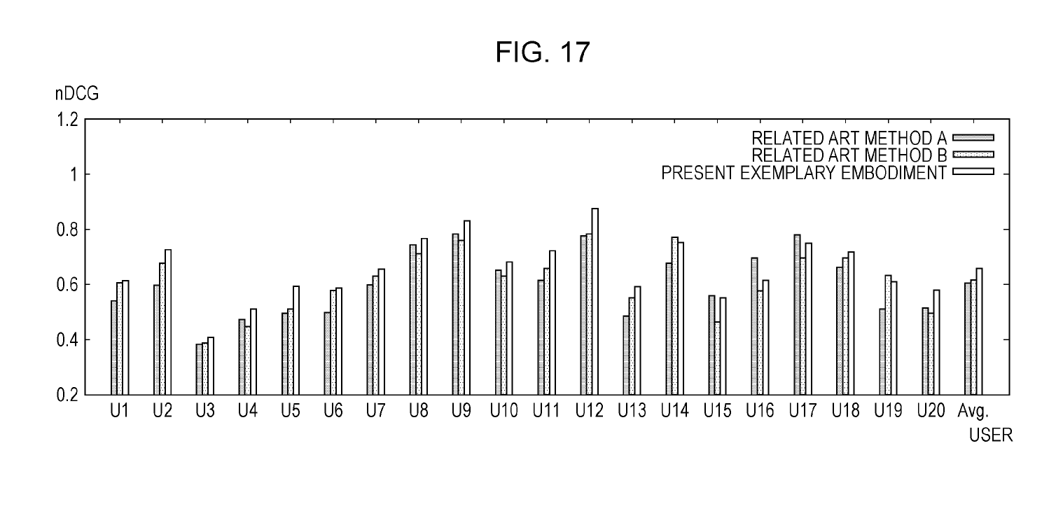

FIG. 17 illustrates nDCG values obtained when the reproduction priorities for movie sections are calculated by using the related art method A, those obtained when the reproduction priorities for the movie sections are calculated by using the related art method B, and those obtained when the reproduction priorities for the movie sections are calculated by using the method according to the exemplary embodiment. FIG. 17 shows that 16 users among 20 users assess the results which are obtained by calculating the reproduction priorities for the movie sections by using the method according to the exemplary embodiment of the present invention, as the most correct ranking.

In the exemplary embodiment, the case in which the generated user profile is applied to a movie reproducing process is described, but the exemplary embodiment is not limiting. For example, the generated user profile is applied to various techniques in various fields, such as multimedia, recommendation for image search, personalized video summarization, artificial intelligence, human computer interaction, and compulsory computing.

In the exemplary embodiment, the case in which the movie reproducing apparatus 10 performs the user-profile generating process illustrated in FIG. 3 and the movie reproducing process illustrated in FIG. 9 is described, but the exemplary embodiment is not limiting. For example, the external server 30 may perform the user-profile generating process. When a movie reproducing apparatus obtains movie information from the external server 30, information indicating a user profile may be obtained along with the movie information. Alternatively, when a movie reproducing apparatus obtains movie information from the external server 30, movie information to which information indicating reproduction priority is attached may be obtained.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A user-profile generating apparatus comprising:
a first generating unit that uses the degree of similarity among a plurality of reference images to generate tree structure information describing a relationship among the plurality of reference images by using a tree structure, the degree of similarity being obtained from feature values of the plurality of reference images; and
a second generating unit that uses feature values of a plurality of target images owned by a user and the feature values of the reference images corresponding to leaf nodes in the tree structure to generate a user profile in which the degree of interest of the user is assigned to each node in the tree structure.

2. The user-profile generating apparatus according to claim 1,
wherein the degree of similarity includes at least two of the degree of visual similarity obtained from a visual feature, the degree of semantic similarity obtained from a semantic feature, and the degree of social similarity obtained from a relationship between the user and each of the plurality of reference images.

3. A movie analyzing apparatus comprising:
a calculating unit that, for each movie section obtained by dividing a movie in accordance with a plurality of time zones, uses the user profile and feature values of frames included in the movie section to calculate the degree of similarity between the user profile and the movie section, and that calculates a reproduction priority for the movie section in accordance with the calculated degree of similarity, the user profile being generated by the user-profile generating apparatus according to claim 1.

4. The movie analyzing apparatus according to claim 3, further comprising:
an adjusting unit that adjusts the reproduction priority for the movie section on a basis of the reproduction priorities for adjacent movie sections before and after the movie section, the reproduction priority being calculated by the calculating unit.

5. The movie analyzing apparatus according to claim 4,
wherein, when both of a first difference and a second difference are equal to or larger than a predetermined threshold, the adjusting unit adjusts the reproduction priority for a target movie section in such a manner that the first difference and the second difference become less than the threshold, the target movie section being the movie section to be adjusted, the first difference being a difference between the reproduction priority for the target movie section and the reproduction priority for the adjacent movie section before the target movie section, the second difference being a difference between the reproduction priority for the target movie section and the reproduction priority for the adjacent movie section after the target movie section.

6. A movie reproducing apparatus comprising:
analyzing apparatus according to claim 3; and
a reproducing unit that, in accordance with the reproduction priorities for the movie sections, the reproduction priorities being calculated by the calculating unit, reproduces the movie while a reproduction speed for the movie section is adjusted.

7. A non-transitory computer readable medium storing a program causing a computer to perform functions of the units of the user-profile generating apparatus according to claim 1.
